(19) United States
(12) Patent Application Publication
(10) Pub. No.: US 2010/0111800 A1
(43) Pub. Date: May 6, 2010

(54) PRODUCTION OF NUCLEAR GRADE ENRICHED GADOLINIUM AND ERBIUM USING VOLATILE Gd OR Er SPECIES USING AN AERODYNAMIC PROCESS

(75) Inventors: Edward J. Lahoda, Pittsburgh, PA (US); Lars Hallstadius, Vasteras (SE); Sture Helmersson, Kolback (SE); Sumit Ray, Columbia, SC (US)

Correspondence Address: WESTINGHOUSE ELECTRIC COMPANY, LLC, P.O. BOX 355, PITTSBURGH, PA, 15230-0355, US

(73) Assignee: Westinghouse Electric Company LLC, Cranberry Township, PA (US)

(21) Appl. No.: 12/603,748

(22) Filed: Oct. 22, 2009

Related U.S. Application Data
(60) Provisional application No. 61/110,650, filed on Nov. 3, 2008.

(51) Int. Cl. C01F 17/00; C25B 1/26; C25B 1/02; C25C 1/02

(52) U.S. Cl. 423/263; 205/620; 205/637; 205/560

(57) ABSTRACT

A method of making Gd or Er isotopes from gaseous compounds containing —BH₄ and —CH₃BH₃ ions involves making the Gd or Er compounds (24) in a solid state reactor (10), passing the gaseous compounds (24) to a separation process (16) to provide products enriched in the desired isotopes of Gd or Er heads and Gd or Er tails depleted in these desired isotopes and then reacting the Gd or Er heads and Gd or Er tails with chlorine in a reactor (18) to provide products of ¹⁵⁷GdCl₃, ¹⁵⁵GdCl₃ or ¹⁶⁷ErCl₃ enriched in Gd and Er isotopes.

### CROSS REFERENCE TO RELATED APPLICATION

This application claims priority under 35 U.S.C. §119 to U.S. Provisional Patent Application Ser. No. 61/110,650, filed Nov. 3, 2008 entitled, PRODUCTION OF NUCLEAR GRADE ENRICHED GADOLINIUM USING VOLATILE Gd SPECIES FROM AN AERODYNAMIC PROCESS.

### BACKGROUND OF THE INVENTION

1. Field of the Invention

The invention relates to use of Gd and Er volatile molecules in the production of Gd and Er isotopes in an aerodynamic separation process.

2. Description of the Prior Art

Processes for separation of vapor phase isotope mixtures utilizing, in part, nozzle-like openings are well known in the art and taught, for example, in U.S. Pat. No. 2,951,554 (Becker). Enhanced nozzle separation is taught in U.S. Pat. Nos. 5,255,404 and 4,297,191 (both Chen). Double deflection nozzles are taught in U.S. Pat. No. 4,551,157 (Becker et al.). The main problem in using these techniques for separating the isotopes of gadolinium and others below is the lack of a volatile molecule containing gadolinium.

In Biro (U.S. Pat. No. 4,565,556), molecular and isotropic fractionating processes for gaseous mixtures are described. The gas mixture to be fractionated is subjected to a helicoidal path and interfered in its free circulation by means of aerodynamic elements to obtain fractions of different weights.

Isotope separation has been practically limited to a few elements due to the fact that the methods commonly available such as nozzle separation, centrifuge or diffusion require a stable, volatile feed material. The use of molecular laser isotope separation (MLIS), such as generally shown in U.S. Pat. No. 3,951,768 (Gürs) provides even more limitations. In addition to requiring a stable compound that is volatile, the compound must also possess absorption bands that are isotopically active in order to work. The use of atomic vapor laser isotope separation (AVLIS) eliminates the need for stable volatile compounds but has difficulties in that the boiling point of gadolinium metal is ˜3200° C. which is difficult to achieve and that making a product that can be readily separated when activated due to its very fine particle size. In addition, AVLIS operations usually require at least two colors of operation (infra red IR) as well as ultra violet (UV)) wavelengths which tremendously increases costs as well as introducing technical issues with timing and product separation. Isotope separation using activation of a chemical reaction or delayed nucleation (CRISLA) are also known and generally taught in U.S. Pat. No. 5,108,566 (Eerkens).

Isotope separation by ion cyclotron resonance (ICR) is also taught by Louvet in U.S. Pat. No. 5,422,481. This method of separation, while technically feasible, is economically unattractive due to its very low production rate and very high capital investment. In addition, the very high boiling point of gadolium and erbium makes this approach very difficult. Producing isotopically separated gadolinium, uranium and many other elements has been a particular problem in this regard. There are many elements with no known, simple (and therefore economic to produce) volatile and stable compounds to work with. Those that have been identified have huge molecular weights such that the weight difference between the different isotopes is very small and the isotopic separation difficulty therefore increases.

Uranium isotope separation has been taught, for example, in U.S. Pat. No. 4,097,384, where attractive volative uranium compounds for use in isotope separation include U(By₄)₄; H₂C(C₅H₄)₂U(BY₄)₂; (C₅H₅)₃U(BY₄); (CH₃H₅)₃U(BY₃C₂H₅) and (C₄H₄N)₃U(BY₄) where Y=H or D (deuterium). Most lower molecular weight Gadolinium compounds (valance +3) are solids: GdCl₃, 6H₂O m.w. 371.76-wh.pr; GdF₃ m.w. 214.30 gelat; Gd₂O₂ m.w. 362.60 amor.powd.; and Gd₂S₂ m.w. 410.78 yel.mass.h.yg. Most lower weight Erbium compounds (valence +3) are solids: Er(NO₃)₃ 6H₂O m.w. 461.76 red. cr; and ER₂O₃ m.w. 383.28 red powd. (Concise Chemical and Technical Dictionary, Ed. H. Bennett, 1962, pp. 368 and 420-421).

Gadolinium and also erbium are extremely valuable rare earth metal isotopes, for use as neutron (“poison”) absorbers in nuclear reactors, as is well known in the art, and are important to the nuclear industry. Gd¹⁵⁷ has excellent neutron absorption capabilities, as described in U.S. Pat. No. 7,318,899 (Lemaire et al.) where such isotopes are separated in an aqueous medium by treating soluble compounds of gadolinium with a ligand designed to complex with at least one of the isotopes and nanofiltering the treated aqueous medium to separate the isotopes. A somewhat similar process was described in U.S. Pat. No. 5,470,479 (Snyder et al.). U.S. Pat. No. 5,595,714 (Ripa et al.) also involves recovery of Gd and its complexing agents from aqueous solutions. Paisner et al. (U.S. Pat. No. 5,202,005) also recognized the importance of Gd¹⁵⁷ and Gd¹⁵⁵ as useful burnable poisons in light water nuclear power reactors. They were enriched by selective photoionization using linear parallel polarized laser beam energy.

Gd and Er “burnable absorbers” which absorb neutrons during nuclear fission, whose ability to absorb neutrons decreases with increased exposure to nuclear fission are recognized by Grossman et al. (U.S. Pat. No. 5,350,542) are separated by atomic vapor laser isotope separation (AVLIS) developed at the Lawrence Livermore National Laboratory. Problems with AVLIS were generally discussed earlier.

Peterson, Lahoda and Weisberg, in U.S. Pat. No. 4,711,768 taught use of a liquid chromatographic column system using an ion-exchange resin and eluent solution to separate Gd isotopes, which Gd is used for nuclear control rods and burnable poison shims, preferably Gd¹⁵⁵ and Gd¹⁵⁷. Problems herein include the low degree of separation per stage (leading to very large and uneconomic columns due to the high cost of the ion-exchange resin) and the low production rate due to the batch operation of the separation column.

Finally, Snyder et al. (U.S. Pat. No. 5,470,479) teaches continuous separation of isotopes of Gd. This method is again not economically feasible because of the very small separation factors that were achieved per theoretical stage.

None of these patents address using gaseous Gd(BH₄)₃ or similar gaseous Er compounds, in an injector nozzle separation device, to produce isotopes of Gd or Er. Again, the reason for this has been the lack of a volatile low molecular weight compound containing gadolinium or erbium.

It is a main object of this invention to provide a method of using gaseous Gd or Er compounds in a process to provide useful Gd and Er isotopes.

### SUMMARY OF THE INVENTION

The above needs have been met and problems solved by providing a method where highly volatile compounds of gadolinium and erbium containing three —BH₄ or —CH₃BH₃, ligands/ions, hereinafter “(Gd, Er)·(—BH₄, —CH₃BH₃)₃ compounds” preferably Gd or Er with —BH₄, are used in an aerodynamic separation process to separate isotopes of gadolinium or erbium. The term aerodynamic separation process (“ASP”) is herein defined to mean any gas flow separation device such as that described in Biro (U.S. Pat. No. 4,565,556), in U.S. Pat. No. 2,951,554 (Becker), in U.S. Pat. No. 5,255,404 (Chen), U.S. Pat. No. 4,297,191 (Chen) or double deflection nozzles as taught in U.S. Pat. No. 4,551,157 (Becker et al.). A carrier gas is used in the ASP process, and is selected from the group consisting of H₂, He and mixtures thereof, preferably at a temperature range of between −50° C. and 400° C., at pressures from vacuums such as 0.001 atmospheres, to pressures up to 100 atmospheres.

In the method, (Gd, Er)·(—BH₄, —CH₃BH₃)ₓ, where x=3 is manufactured as a gaseous starting product or starting “Product”. That starting Product is passed to an ASP process, as generally described previously to provide Gd or Er heads and Gd or Er tails. The term “heads” means a product enriched in the concentration of the desired isotopes. The term “tails” means a waste stream depleted in the concentration of the desired isotopes. These heads and tails are then reacted with Cl₂ gases. This is generally shown in the FIGS.

More specifically, the invention preferably utilizes Gd(BH₄)₃ or Er(BH₄)₃ and involves a method of providing gaseous Gd or Er isotopes comprising: (a) reacting a solid starting product material selected from the group consisting of GdCl₃ or ErCl₃ in a reactor with LiBH₄ to provide a reaction product selected from the group consisting of gaseous Gd(BH₄)₃, or gaseous Er(BH₄)₃ and solid LiCl; (b) passing the gaseous reaction product into an aerodynamic separation process utilizing an injector nozzle in a stationary reactor to produce centrifugal force/spiraling or swirling gases while utilizing a carrier gas selected from the group selected from the group consisting of H₂, He and mixtures thereof, to provide heads and tails selected from the group selected from Gd or Er heads and Gd or Er tails; and (c) passing the heads and tails to a reactor to react with Cl₂ to provide BCl₃ and HCl off gases and final solid product selected from the group consisting of ¹⁵⁷GdCl₃, ¹⁵⁵GdCl₃ and ¹⁶⁷ErCl₃ rich in Gd and Er isotopes.

In the above method, the BCl₃ and HCl off gases from step (c) are passed to an electrolysis unit where LiCl from step (a) is reacted with HCl from a separate reactor where H₂ and Li from the electrolysis unit and BCl₃ from step (c) are reacted to provide LiBH₄ which is fed into step (a) and HCl which is passed to the electrolysis unit.

### BRIEF DESCRIPTION OF THE DRAWINGS

A further understanding of the invention can be gained from the following description of the preferred embodiments when read in conjunction with accompanying drawings in which:

FIG. 1 is a simple, block diagram of the method of this invention involving Gd (valence=+3) isotope separation using a —BH₄ ligand; and

FIG. 2 is a simple, block diagram of the method of this invention involving Er (valence=+3) isotope separation using a —BH₄ ligand.

### DESCRIPTION OF THE PREFERRED EMBODIMENT

Gd and Er compounds are synthesized using —BH₄ or —(CH₃BH₃) ligands/ions. These compounds of gadolinium and erbium have overcome all the barriers described in the BACKGROUND above. These compounds are relatively stable, have low molecular weights and are simple to produce. Boron (B) has two isotopes with concentrations of 19.9% of B10 and 80.1% of B11. In order to improve the per pass yield in the separation step, a single isotope of boron or more likely an isotopic mix that is enriched in either B10 or B11, could be used (see for instance, U.S. Pat. No. 5,443,732 “Boron isotope separation using continuous ion exchange chromatography” or U.S. Pat. No. 5,419,887 “Separation of the isotopes of boron by chemical exchange reactions”.) The term “isotropic mix” means the same element with more than one isotope.

In addition, the use of an aerodynamic separation process to produce a Gd product enriched in Gd157 isotopes overcomes the issues associated with other isotope separation processes. For erbium, the Er167 isotope would be enriched. The aerodynamic process utilizes compressors to increase carrier gas pressure that contains the volatile form of Gd or other element, and carrier gas 25 (either He or H₂, or their mixture) is then injected by injector nozzle separation device 26 at pressures between 0.001 atmospheres to 100 atmospheres, preferably 2 atmospheres to 10 atmospheres to affect a spinning/swirling motion in the gas, that results in the centrifugal separation of the isotope of Gd or other element of interest by centrifugal force. The carrier gas temperature can range from −50° C. to 400° C., preferably from 25° C. to 200° C. The process does not break bonds, forming lower molecular weight volatile species that are hard to collect and separate from the products as do laser isotope separation methods. It has a much lower cost than diffusion methods. The process can also operate at elevated temperatures, where actual centrifuges are not operable. The process of this invention involves a gas swirling around inside a tank rather than spinning the tank, as well as lower temperatures, for instance −50° C. So, for example, it is possible to operate at any elevated temperature such as up to 400° C., which allows sufficient volatility of the compound whose isotope is being separated. The pressures that are used in the process would range from vacuums of about 0.001 atmospheres to pressures up to 100 atmospheres, as previously mentioned.

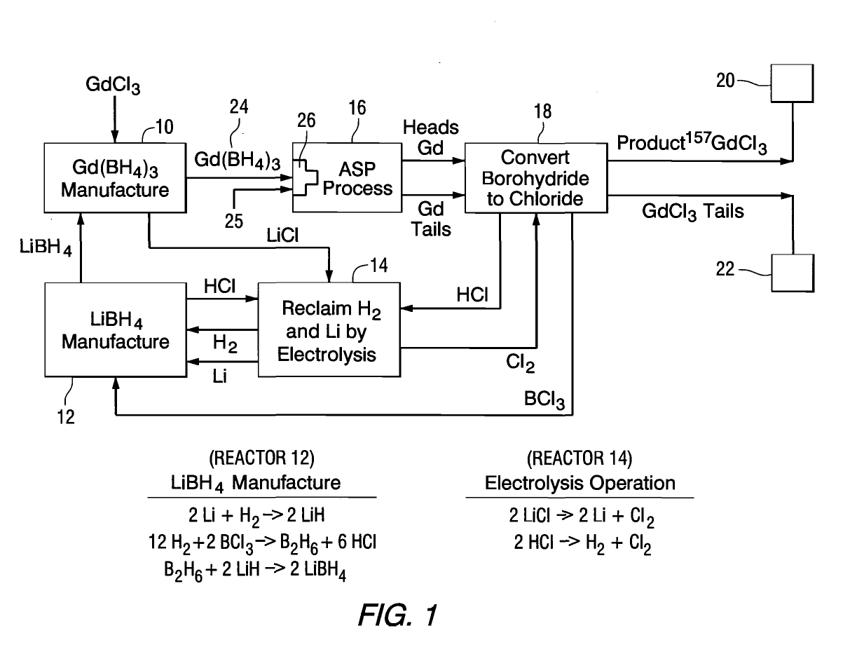

In this invention, referring to FIG. 1, treating the preferred material Gd, GdCl₃ is reacted with LiBH₄ by ball-milling them together at atmospheric pressure at room to slightly elevated (100° C.) in a water vapor free enclosure to provide Gd(BH₄)₃ (“Product”: 24) in a reactor 10. The LiBH₄ is manufactured in reactor 12 by combining BCl₃, Li and H₂ according to the reactions:

2Li+H₂→2LiH; 12H₂+2BCl₃→B₂H₆+6HCl, and

B₂H₆+2LiH→2LiBH₄.

The Li is produced in reactor 14, in an electrolysis process, wherein LiCl product from reactor 10 and HCl product from reactor 12 are reacted with HCl, with the overall reactions:

2LiCl→2Li+Cl₂, and

2HCl→H₂+Cl₂.

In the ASP process reactor 16, preferably the Gd (BH₄)₃ or Er(BH₄)₃, or other “Product,” is mixed with carrier gas (hydrogen and/or helium) and raised to pressures of preferably 2 to 10 atmospheres at temperatures from 25° C. to 400° C. The carrier gas with product is then injected through nozzles 26 and into a stationary, non-spinning collection chamber, generating sufficient centrifugal forces to cause gas swirling and separation of the various isotopes of the gadolinium or erbium.

Subsequently, Gd heads and Gd tails, previously defined, are fed to a separate reactor 18 to convert borohydride to chloride by reaction with Cl₂ feed, to form BCl₃ and ¹⁵⁷GdCl₃ or ¹⁵⁵GdCl₃ heads (product 20) and GdCl₃ tails (product 22). GdCl₃ is a solid and will therefore separate readily from the Cl₂, HCl and BCl₃. These reactions will be viable with all components of (Gd, Er)·(—BH₄, —CH₃BH₃)₃ components.

An electrolysis process 14 is used in this invention to convert the LiC to Cl₂ which is fed to reactor 18, and H₂ and Li is fed to reactor 12.

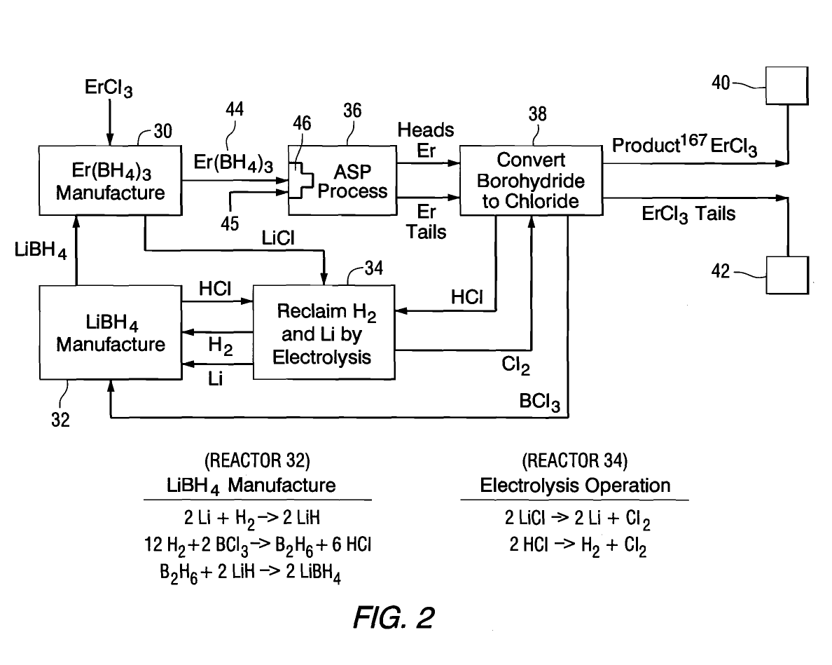

FIG. 2 provides a similar process for utilizing Er (valence +3, the same as Gd). Such reactions are completely similar; only Er is substituted for Gd in the process. This FIG. 2 is incorporated into the specification as a duplicate of FIG. 1 with all reaction parameters in reactors 30, 32, 36 and 38 being the same and providing similar products 40; ¹⁶⁷ErCl₃ and tails 42. Er (BH₄)₃ starting Product is shown as 44, the injector as 46 and the electrolysis reactor as 34.

Thus, Gd157, Gd155, and Er167 are isotopes of Gd or Er and the product heads are rich in those isotopes in the chemical form of GdCl₃ or ErCl₃ and the waste tails are depleted in those isotopes in the chemical form GdCl₃ or ErCl₃.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the breath of the appended claims and any and all equivalents thereof.

What is claimed is:

1. A method for separation of the isotopes of Gd and Er from gaseous Gd and Er compounds containing —BH₄ or —CH₃BH₃ ligands in an aerodynamic separation process comprising the steps of:
(a) making the Gd or Er compounds with high volatility that are put into a gaseous state;
(b) passing the gaseous Gd or Er compounds to an aerodynamic separation process to provide Gd or Er heads and Gd or Er tails; and then
(c) reacting the Gd or Er heads and Gd or Er tails with chlorine to produce either solid GdCl₃ or ErCl₃ product enriched in Gd or Er isotopes.

2. The method of claim 1, wherein isotopically separated boron (B) is used to maximize the yield of the aerodynamic separation process.

3. The method of claim 1, wherein a carrier gas selected from the group consisting of H₂, He and mixtures thereof is used in the aerodynamic separation process of step (b).

4. The method of claim 3, wherein the carrier gas is at temperatures between −50° C. and 400° C. in the aerodynamic separation process.

5. The method of claim 3, wherein the carrier gas is at pressures between 0.001 atmospheres and 100 atmospheres in the aerodynamic separation process.

6. The method of claim 1, wherein Gd compounds are made in step (a) and the product in step (c) is a mixture of GdCl₃ enriched in the isotopes of ¹⁵⁷Gd and/or ¹⁵⁵Gd.

7. The method of claim 1, wherein Er compounds are made in step (a) and the product in step (c) is a mixture of ErCl₃ enriched in the isotopes of ¹⁶⁷Er.

8. The method of claim 1, wherein the ligand is —BH₄.

9. A method of providing solid gaseous GdCl₃ and ErCl₃ enriched in the desired isotopes comprising:
(a) reacting a solid starting product material selected from the group consisting of GdCl₃ or ErCl₃ in a reactor with LiBH₄ to provide a reaction product selected from the group consisting of gaseous Gd(BH₄)₃ or gaseous Er(BH₄)₃ and solid LiCl;
(b) passing the gaseous reaction product with a carrier gas selected from the group consisting of H₂, He and mixtures thereof into an aerodynamic separation process utilizing an injector nozzle in a stationary reactor to produce centrifugal force to provide a heads product and tails product where the heads product is enriched in one or more of the isotopes ¹⁵⁵Gd, ¹⁵⁷Gd or ¹⁶⁷Er; and
(c) passing the heads and tails to a reactor to react with Cl₂ to provide BCl₃ and HCl off gases, and final solid product containing one or more enriched products, containing enriched isotopes, the products selected from the group consisting of ¹⁵⁷GdCl₃ ¹⁵⁵GdCl₃ and ¹⁶⁷ErCl₃.

10. The method of claim 9, wherein the BCl₃ and HCl off gases from step (c) and LiCl from step (a) are passed to an electrolysis unit where H₂, Cl₂ and Li are formed.

11. The method of claim 10, wherein Li and H₂ from the electrolysis unit and BCl₃ from step (c) are used to make LiBH₄ which is fed into step (a), and HCl which is passed to the electrolysis unit.

12. The method of claim 9, wherein the carrier gas in step (b) is at a temperature between −50° C. and 400° C.

13. The method of claim 9, wherein the carrier gas is at a pressure between 0.001 atmospheres and 100 atmospheres.

14. The method of claim 9, wherein the aerodynamic process causes gas swirling.
